(19) United States
(12) Patent Application Publication
(10) Pub. No.: US 2009/0164430 A1
(43) Pub. Date: Jun. 25, 2009

(54) SYSTEM AND METHOD FOR ACQUIRING CONTACT INFORMATION

(75) Inventor: Mu-Ann Chen, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/195,422

(22) Filed: Aug. 21, 2008

(30) Foreign Application Priority Data
Dec. 19, 2007 (CN) 200710203229.5

(51) Int. Cl. G06F 17/30; G06F 7/06

(52) U.S. Cl. 707/3; 707/102; 707/E17.009

(57) ABSTRACT

An exemplary method for acquiring contact information in an electronic device is disclosed. The method is for generating a plurality E-mail index of all E-mail addresses stored in the electronic device, and inserting the E-mail index into a generated E-mail index list. When the electronic device receives an E-mail from a sender, corresponding contact information of the sender may be acquired by utilizing the method.

### BACKGROUND

1. Field of the Invention

Embodiments of the present disclosure relate to systems and methods for processing data, and particularly to a system and method for acquiring contact information in an electronic device.

2. Description of Related Art

Electronic devices are continuously integrated with improved and/or increased functionalities. More and more electronic devices, such as mobile phones, can be used for sending or receiving E-mails. However, these electronic devices may only show an E-mail address of a sender, or show a phone number of the sender. In other words, no related contact information, such as a name of the sender, is shown on the E-mail except the E-mail address or the phone number. Thus, a receiver of the E-mail cannot know more information about the sender.

Some electronic devices may search for corresponding contact information of the sender of the E-mail by comparing the E-mail address received from the sender with the E-mail addresses stored in the electronic devices one by one. Such a comparison method is inefficient.

What is needed, therefore, is a system and method for remedying the above-mentioned deficiencies.

### SUMMARY

A computing system for acquiring contact information is provided. The system includes a string parsing module, a converting module, an index generating module, a correlating module, and at least one processor. The string parsing module is configured for predetermining at least one separator, and parsing a character string of an E-mail address, stored in a storage device of the system, into a predetermined number of sub-strings according to the separator. The converting module is configured for converting each character in each of the sub-strings from uppercase characters to lowercase characters, determining an ASCII value of each character in each of the sub-strings, determining an ASCII sum of each of the sub-strings by adding the ASCII value of each character in each of the sub-strings, and converting the ASCII sum of each of the sub-strings into a converted value. The index generating module is configured for generating an E-mail index of the E-mail address by combining the last two characters of each converted value, generating an E-mail index list, and storing the E-mail index in the storage device of the system. The correlating module is configured for correlating the E-mail index to corresponding contact information of the E-mail address. The at least one processor executes the string parsing module, the converting module, the index generating module, and the correlating module so as to generate E-mail indexes corresponding to other E-mail addressed stored in the storage device, inserting the E-mail indexes into the E-mail index list, and correlating the E-mail indexes to the corresponding contact information of the E-mail addresses respectively.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a block diagram of one embodiment of a system for acquiring contact information.

FIG. 2 is a flowchart of one embodiment of a method for generating an E-mail index list of E-mail addresses.

FIG. 3 is a flowchart of one embodiment of a method for acquiring contact information.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

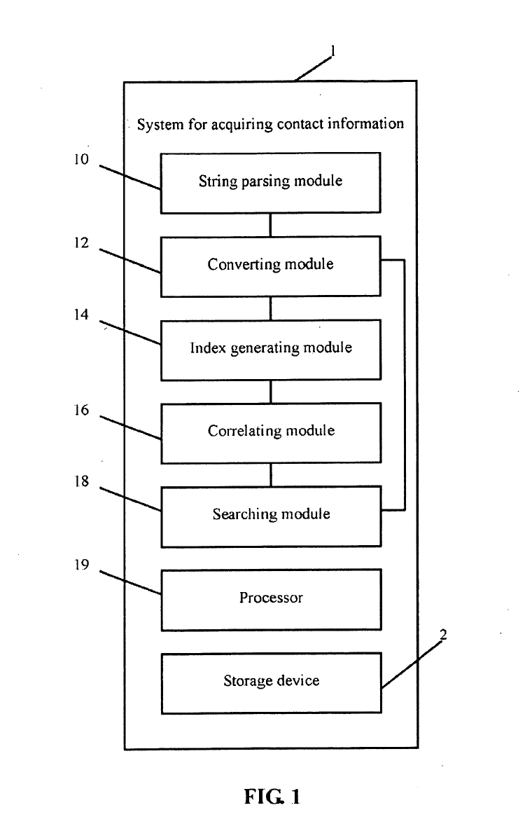

FIG. 1 is a block diagram of one embodiment of a system 1 for acquiring contact information. Depending on the embodiment, the system 1 may be a computer, a mobile phone, a notebook, a PDA (personal digital assistant), for example.

The system 1 comprises a storage device 2. The storage device 2 stores various kinds of data, such as a contact list, E-mails, messages, for example. Depending on the embodiment, the storage device 2 may comprise a memory of the system 1 or an external storing card, such as a memory stick, a Subscriber Identity Module (SIM) card, for example. The contact list may include various information, such as names of people, address information, E-mail information, and phone number information, for example.

The system 1 is configured for analyzing E-mail addresses in the contact list (hereinafter referred to as “the contact list E-mail address”) stored in the storage device 2 so as to generate a plurality of E-mail indexes. Each of the plurality of E-mail indexes correspond to each E-mail address in the contact list. The system 1 is further configured for analyzing a received E-mail address (hereinafter referred to as “the received E-mail address”) from a sender, and searching the storage device 2 for specified contact information according to the received E-mail address and the plurality of E-mail indexes. In one embodiment, the system 1 includes a string parsing module 10, a converting module 12, an index generating module 14, a correlating module 16, and a searching module 18. A processor 19 may execute the string parsing module 10, the converting module 12, the index generating module 14, the correlating module 16, and the searching module 18.

It may be understood that each of the contact list E-mail address and the received E-mail address is a character string formed by a plurality of characters. The characters may be uppercase characters, lowercase characters, or numbers. A contact list E-mail address is read and passed to the string parsing module 10 as a character string.

The string parsing module 10 is configured for predetermining at least one separator, and parsing the character string into a predetermined number of sub-strings. In one exemplary embodiment, two predetermined separators may be an “at” character (“@”) and a period character (“.”), and the predetermined number of sub-strings is four.

most E-mail addresses include one “at” character (“@”) and at least one period character (“.”), such as “Anna@foxconn.com,” “Hank@yahoo.com.tw,” and “kim@mail.rul.com.tw.” If the E-mail address contains two period characters, the character string of the E-mail address is divided into four sub-strings. If the E-mail address contains only one period character, the character string of the E-mail address is divided into three sub-strings plus a NULL string, and if the E-mail address has more than two period characters, the remaining periods are omitted and remaining characters following the second period character are combined as a single substring. For example, the E-mail address of “Anna@foxconn.com” may be divided into four sub-strings as follows: “Anna,” “foxconn,” “com,” and “null.” The E-mail address of “Hank@yahoo.com.tw” may be divided into four sub-strings as follows: “Hank,” “yahoo,” “com,” and “tw.” The E-mail address of “kim@mail.rul.com.tw” may be divided into four sub-strings as follows: “kim,” “mail,” “rul,” and “comtw.” In other embodiments, the separator and the predetermined number of the sub-strings may be set or modified according to user requirements.

The converting module 12 is configured for converting each character in each of the sub-strings from uppercase characters to lowercase characters, determining an ASCII value for each of the characters in each of the sub-strings, and determining an ASCII sum for each of the sub-strings by adding the ASCII values of each of the characters in each of the sub-strings. Depending on the embodiment, the ASCII values may be represented with decimal ASCII values, binary ASCII values, octal ASCII values, or hexadecimal ASCII values. It may be understood that the term, “character” may refer to one of the twenty-six letters of the English alphabet.

For example, if the E-mail address of “Hank@yahoo.com.tw” has four sub-strings, such as “Hank,” “yahoo,” “com,” and “tw,” the first sub-string “Hank” is converted to be “hank.” In the converted first sub-string “hank,” a decimal ASCII value of the character “h” is “104,” a decimal ASCII value of the character “a” is “97,” a decimal ASCII value of the character “n” is “110,” and a decimal ASCII value of the character “k” is “107.” An ASCII sum of the converted first sub-string “hank” is determined as “418” by adding the decimal ASCII values of “104,” “97,” “110,” and “107.” In a similar calculation, an ASCII sum of the secondary sub-string “yahoo” is determined as “608,” an ASCII sum of the third sub-string “com” is determined as “365,” and an ASCII sum of the fourth sub-string “tw” is determined as “281.”

The converting module 12 is further configured for converting the ASCII sum of each of the sub-strings into a converted value. In one embodiment, the converted value is a hexadecimal value and in other embodiments, the converted value may be one of a binary value, an octal value, and a decimal value.

For example, the ASCII sum “418” of the converted first sub-string “hank” is converted to be a hexadecimal value “0x1A2.” In a similar conversion, the ASCII sum “608” of the secondary sub-string “yahoo” is converted to be a hexadecimal value “0x260,” the ASCII sum “365” of the third sub-string “com” is converted to be a hexadecimal value “0x16D,” and the ASCII sum “281” of the fourth sub-string “tw” is converted to be a hexadecimal value “0x119.”

The index generating module 14 is configured for generating an E-mail index of the contact list E-mail address by combining the last two characters of each converted value of the sub-strings. For example, the E-mail address of “Hank@yahoo.com.tw” has four hexadecimal values “0x1A2,” “0x260,” “0x16D,” and “0x119.” The last two characters of the hexadecimal values are “A2,” “60,” “6D,” and “19,” then a combination value is acquired as “A2606D19,” which is regarded as an E-mail index of the contact list E-mail address of “Hank@yahoo.com.tw.”

The correlating module 16 is configured for correlating the E-mail index to corresponding contact information of the contact list E-mail address such that the contact information may be acquired through the E-mail index. In one exemplary embodiment, it is assumed that the E-mail addresses stored in the storage device 2 have corresponding contact information. For example, contact information corresponding to the E-mail address of “Hank@yahoo.com.tw” includes a contact name “hank,” phone numbers “***,” then the E-mail index “A2606D19” of the E-mail address of “Hank@yahoo.com.tw” is correlated to the contact information.

All of the contact list E-mail addresses stored in the storage device 2 are processed by the string parsing module 10, the converting module 12, the index generating module 14, and the correlating module 16 so as to acquire corresponding E-mail indexes, and correlate the E-mail indexes to the corresponding contact information of the contact list E-mail addresses. The index generating module 14 is further configured for arranging the E-mail indexes in a sequence, generating an E-mail index list, and storing the E-mail indexes and the E-mail index list into the storage device 2.

The searching module 18 is configured for reading a received E-mail address when the electronic device receives an E-mail. The received E-mail address is processed to generate an E-mail index of the received E-mail address by utilizing the string parsing module 10, the converting module 12, and the index generating module 14.

The searching module 18 is also configured for searching the E-mail index list in the storage device 2 for the E-mail index of the received E-mail address, and determining if the E-mail index of the received E-mail address can be found in the E-mail index list. If the E-mail index of the received E-mail address is found, the searching module 18 determines if the contact list E-mail address corresponding to the found E-mail index is substantially the same as the received E-mail address. If the contact list E-mail address corresponding to the found E-mail index is substantially the same as the received E-mail address, the searching module 18 reads the contact information corresponding to the found E-mail index. Then, the read contact information is displayed on a user interface of the electronic device so that the identity of the sender of the received E-mail may be known and displayed.

If the E-mail index of the received E-mail address is not found, or if no E-mail index in the E-mail index list is substantially the same as the received E-mail address, the searching module 18 is further configured for displaying a dialog box prompting that the storage device 2 has no contact information corresponding to the received E-mail address. Afterwards, the E-mail index of the received E-mail address may be put in the E-mail index list, and the contact information corresponding to the received E-mail address may be added and correlated to the E-mail index of the received E-mail, if the contact information is acquired.

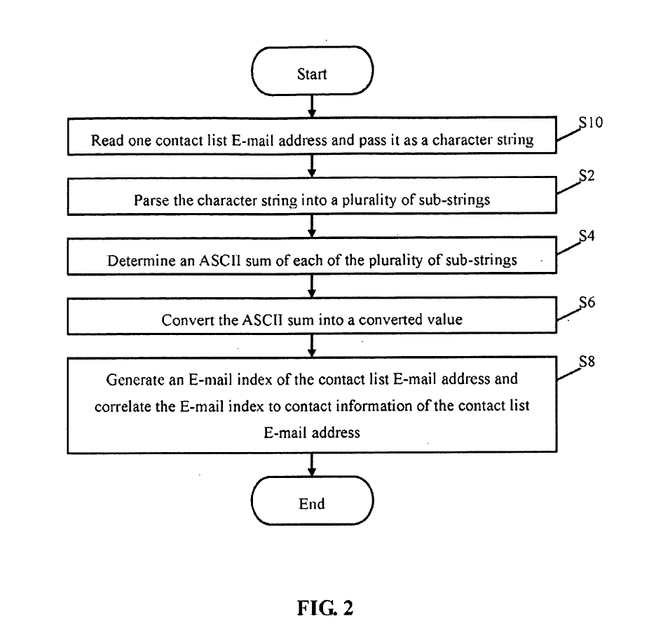

FIG. 2 is a flowchart of one embodiment of a method for generating an E-mail index list of E-mail addresses. Depending on the embodiment, additional blocks may be added or deleted and the blocks may be executed in a different order than described. In block S1, one of the contact list email addresses is read and passed to the string parsing module 10 as a character string. In block S2, the string parsing module 10 parses the character string into a predetermined number of sub-strings according to at least one predetermined separator. In one exemplary embodiment, the string parsing module 10 is preconfigured with two predetermined separators, such as the “at” character (“@”) and the period character (“.”), and the character string is parsed into four sub-strings according to the two separators.

In block S4, the converting module 12 converts each of the characters in each of the sub-strings from uppercase characters to lowercase characters, determines the ASCII values of each of the characters in each of the sub-strings, and determines the ASCII sum of each of the sub-strings by adding the ASCII values of each of the characters in each of the sub-strings. In one exemplary embodiment, the ASCII values are decimal ASCII values.

In block S6, the converting module 12 converts the ASCII sum of each of the sub-strings into the converted value. In one exemplary embodiment, the converted value is a hexadecimal value.

In block S8, the index generating module 14 generates the E-mail index of the contact list E-mail address by combining the last two characters of each converted value, and the correlating module 16 correlates the E-mail index to corresponding contact information of the contact list E-mail address such that the contact information may be acquired through the E-mail index.

Another contact list email address is read and processed by repeating block S2 to block S8 as described above, so as to acquire corresponding E-mail index and correlate the E-mail index to the corresponding contact information of the contact list E-mail addresses. The index generating module 14 arranges all the E-mail indexes in a sequence, generates the E-mail index list, and stores the E-mail index list into the storage device 2. For example, all the indexes may be arranged in an alphabetic sequence or a numerical sequence.

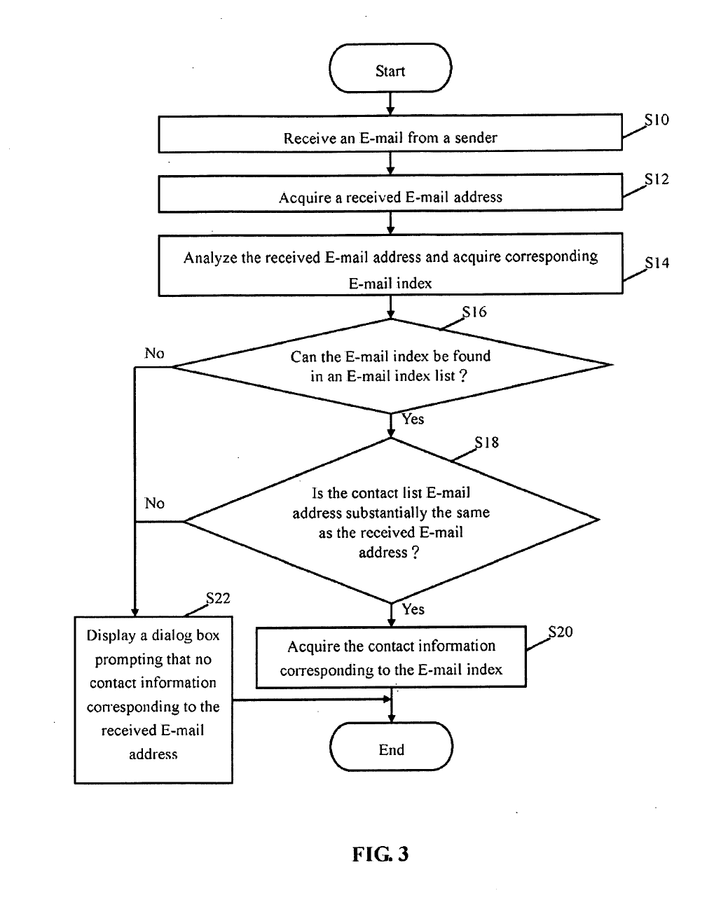

FIG. 3 is a flowchart of one embodiment of a method for acquiring contact information. Depending on the embodiment, additional blocks may be added or deleted and the blocks may be executed in a different order than described. In block S10, the electronic device receives an E-mail otherwise known as the received E-mail address.

In block S12, the searching module 18 reads the received E-mail address. In block S1 4, the received E-mail address is processed to generate the E-mail index of the received E-mail address by repeating block S2 to block S8 of FIG. 2.

In block S16, the searching module 18 searches the E-mail index list in the storage device 2 for the E-mail index of the received E-mail address, and determines if the E-mail index of the received E-mail address can be found in the E-mail index list. If the E-mail index of the received E-mail address cannot be found in the E-mail index list, the procedure goes to block S22 directly.

If the E-mail index of the received E-mail address is found in the E-mail index list, in block S18, the searching module 18 determines if the contact list E-mail address corresponding to the E-mail index is substantially the same as the received E-mail address. If the contact list E-mail address corresponding to the E-mail index is substantially the same as the received E-mail address, in block S20, the searching module 18 reads the contact information corresponding to the found E-mail index. Then the read contact information is displayed on the user interface of the electronic device so that the identity of the sender of the received E-mail may be known. If the contact list E-mail address corresponding to the E-mail index is different from the received E-mail address, in block S22, the searching module 18 displays the dialog box prompting that the storage device 2 has no contact information corresponding to the received E-mail address.

It should be emphasized that the above-described embodiments, particularly, any “exemplary” embodiments, are merely possible examples of implementations, and set forth for a clear understanding of the principles of the invention. Many variations and modifications may be made to the above-described embodiment(s) without departing substantially from the spirit and principles of the invention. All such modifications and variations are intended to be included herein within the scope of this disclosure and the above-described embodiment(s), and the present disclosure is protected by the following claims.

What is claimed is:

1. A computing system for acquiring contact information, the system comprising:
a string parsing module configured for predetermining at least one separator, and parsing a character string of an E-mail address, stored in a storage device of the system, into a predetermined number of sub-strings according to the separator;
a converting module configured for converting each character in each of the sub-strings from uppercase characters to lowercase characters, determining an ASCII value of each character in each of the sub-strings, determining an ASCII sum of each of the sub-strings by adding the ASCII value of each character in each of the sub-strings, and converting the ASCII sum of each of the sub-strings into a converted value;
an index generating module configured for generating an E-mail index of the E-mail address by combining the last two characters of each converted value, generating an E-mail index list, and storing the E-mail index in the storage device of the system;
a correlating module configured for correlating the E-mail index to corresponding contact information of the E-mail address; and
at least one processor executing the string parsing module, the converting module, the index generating module, and the correlating module so as to generate E-mail indexes corresponding to other E-mail addressed stored in the storage device, inserting the E-mail indexes into the E-mail index list, and correlating the E-mail indexes to the corresponding contact information of the E-mail addresses respectively.

2. The system as claimed in claim 1, further comprising a searching module configured for reading a received E-mail address of an E-mail, the received E-mail address being processed to generate an E-mail index of the received E-mail address by utilizing the string parsing module, the converting module, and the index generating module.

3. The system as claimed in claim 2, wherein the searching module is further configured for searching the E-mail index list for the E-mail index of the received E-mail address, determining if the E-mail index of the received E-mail address can be found in the E-mail index list, and further determining if the E-mail address stored in the storage device corresponding to the found E-mail index is substantially the same as the received E-mail address.

4. The system as claimed in claim 3, wherein the searching module is further configured for reading contact information corresponding to the found E-mail index if the E-mail address stored in the storage device corresponding to the found E-mail index is substantially the same as the received E-mail address.

5. The system as claimed in claim 3, wherein the searching module is further configured for displaying a dialog box prompting that the storage device has no contact information corresponding to the received E-mail address, if the E-mail index of the received E-mail address cannot be found in the E-mail index list, or if the E-mail address stored in the storage device corresponding to the found E-mail index is different from the received E-mail address.

6. The system as claimed in claim 1, wherein the separator is predetermined to be an “at” character, a period character, or a combination of the “at” character and the period character.

7. The system as claimed in claim 1, wherein the predetermined number of sub-strings of the E-mail address is four.

8. The system as claimed in claim 1, wherein the index generating module is further configured for arranging all E-mail indexes in a sequence.

9. An electronic method for acquiring contact information in an electronic device, the method comprising:
predetermining at least one separator, and parsing a character string of an E-mail address, stored in a storage device of the electronic device, into a predetermined number of sub-strings according to the separator;
converting each character from uppercase characters to lowercase characters in each of the sub-strings;
determining an ASCII value for each character in each of the sub-strings;
determining an ASCII sum for each of the sub-strings by adding the ASCII value of each character in each of the sub-strings, and converting the ASCII sum of each of the sub-strings into a converted value;
generating an E-mail index of the E-mail address by combining the last two characters of each converted value, generating an E-mail index list, and storing the E-mail index list in the storage device;
correlating the E-mail index to corresponding contact information of the E-mail address; and
repeating the converting step to the correlating step until generating E-mail indexes corresponding to all E-mail addresses stored in the storage device, inserting the E-mail indexes into the E-mail index list, and correlating the E-mail indexes to the corresponding contact information of the E-mail addresses respectively.

10. The method according to claim 9, further comprising:
reading a received E-mail address of a received E-mail;
executing the converting step to the correlating step for generating an E-mail index of the received E-mail address.

11. The method according to claim 10, further comprising:
searching the E-mail index list for the E-mail index of the received E-mail address;
determining if the E-mail index of the received E-mail address can be found in the E-mail index list;
determining if the E-mail address stored in the storage device corresponding to the found E-mail index is substantially the same as the received E-mail address, if the E-mail index of the received E-mail address is found in the E-mail index list; and
reading contact information corresponding to the found E-mail index if the E-mail address stored in the storage device corresponding to the found E-mail index is substantially the same as the received E-mail address.

12. The method according to claim 11, further comprising:
displaying a dialog box prompting that no contact information corresponding to the received E-mail address is provided, if the E-mail index of the received E-mail address cannot be found in the E-mail index list, or if the E-mail address stored in the storage device corresponding to the found E-mail index is different from the received E-mail address.

13. The method according to claim 9, wherein the separator is predetermined to be an “at” character, a period character or a combination of the “at” character and the period character.

14. The method according to claim 9, further comprising:
arranging all E-mail indexes in a sequence.

15. A computer-readable medium having stored thereon instructions that, when executed by a computer, causing the computer to perform a method for acquiring contact information in an electronic device, the medium comprising:
predetermining at least one separator, and parsing a character string of the E-mail address, stored in a storage device of the electronic device, into a predetermined number of sub-strings according to the separator;
converting each character from uppercase characters to lowercase characters in each of the sub-strings;
determining an ASCII value for each character in each of the sub-strings;
determining an ASCII sum for each of the sub-strings by adding the ASCII value of each character in each of the sub-strings, and converting the ASCII sum of each of the sub-strings into a converted value;
generating an E-mail index of the E-mail address by combining the last two characters of each converted value, generating an E-mail index list, and storing the E-mail index list into the storage device;
correlating the E-mail index to corresponding contact information of the E-mail address; and
repeating the converting step to the correlating step until generating E-mail indexes corresponding to all E-mail addresses stored in the storage device, inserting the E-mail indexes into the E-mail index list, and correlating the E-mail indexes to the corresponding contact information of the E-mail addresses respectively.

16. The computer-readable medium according to claim 15, further comprising:
reading a received E-mail address of a received E-mail;
executing the converting step to the correlating step for generating an E-mail index of the received E-mail address.

17. The computer-readable medium according to claim 15, further comprising:
searching the E-mail index list for the E-mail index of the received E-mail address;
determining if the E-mail index of the received E-mail address can be found in the E-mail index list;
determining if the E-mail address stored in the storage device corresponding to the found E-mail index is substantially the same as the received E-mail address, if the E-mail index of the received E-mail address is found in the E-mail index list; and
reading contact information corresponding to the found E-mail index if the E-mail address stored in the storage device corresponding to the found E-mail index is substantially the same as the received E-mail address.
